(19) United States
(12) Patent Application Publication
(10) Pub. No.: US 2008/0221224 A1
(43) Pub. Date: Sep. 11, 2008

(54) UNIMOLECULAR TWEEZERS

(76) Inventor: Sergei S. Sheiko, Chapel Hill, NC (US)

Correspondence Address: MOORE & VAN ALLEN PLLC, P.O. BOX 13706, Research Triangle Park, NC, 27709, US

(21) Appl. No.: 11/682,427

(22) Filed: Mar. 6, 2007

(51) Int. Cl. C08F 20/06; C08F 20/56; C08F 26/06; C08F 28/06; C08F 30/08

(52) U.S. Cl. 514/789; 520/1; 525/327.1; 525/328.5; 525/329.4; 525/329.7; 525/333.3; 525/333.7

(57) ABSTRACT

Macromolecules may be specially designed so that upon adsorption at a substrate, the macromolecules experience intramolecular tension at their covalent bonds due to the physical interaction of the molecular segments of the macromolecules with the substrate. As a result of the induced tension, the macromolecules may be used in a number of applications including, but not limited to, environmental and surface sensors, chemical activators and catalysts, and molecular probes.

### GOVERNMENT RIGHTS IN THE INVENTION

The United States Government has rights to this invention pursuant to National Science Foundation grant number DMR-0306787.

### FIELD OF THE INVENTION

The present invention relates to specially designed macromolecules which upon adsorption at a surface experience intramolecular tension at their covalent bonds due to the physical interaction of the monomeric units of the macromolecules with the surface. As a result of the induced tension, the macromolecules may be used in a number of applications including, but not limited to, sensors for probing environmental properties, chemical activators for initiating chemical reactions at specific bonds of macromolecules, molecular degradation triggers, and tools (e.g. molecular tweezers) for extending specific chemical bonds such as covalent and metallic bonds, whereby the molecular tweezers may be also used to extend/stretch physical bonds such as hydrogen bonds.

### DESCRIPTION OF THE RELATED ART

Molecular probes such as optical tweezers and magnetic tweezers have emerged for use in many biological, microfluidic and micromechanical systems. Optical tweezers require the use of a laser beam to provide an attractive force to physically transport transparent particles. Magnetic tweezers utilize magnetic fields to manipulate single molecules using controllable paramagnetic interactions. Uses of optical and magnetic tweezers include, but are not limited to, the study of binding forces, the adhesion properties of cells, and molecular motors (i.e., where proteins absorb chemical energy and convert it to mechanical work). Disadvantageously, for both optical and magnetic tweezers, energy/tension must be provided by an outside source.

The inventor of the present invention has surprisingly discovered that tension may be spontaneously generated within a molecule upon adsorption of a highly branched macromolecule onto a substrate. This tension changes the electronic stricture of adsorbed macromolecules along with their optical and electronic properties. The amount of tension may be controlled by either adjusting the strength of the adsorption forces or by varying the branching topology, the length of branches, and/or branching density. The adsorption forces can be controlled by varying the substrate, the surrounding environment, and/or the chemical compositional make-up of the macromolecule. As a result, the macromolecules may be useful as sensors for probing environmental properties or as miniature tools for extending specific covalent bonds and thus inducing chemical reactions.

It is well known in the art that carbon has the ability to form long chains of interconnecting carbon-carbon bonds and that these C—C bonds are abnormally stable and thus difficult to break. For example, it is known that a force of several nanonewtons is needed to extend and rupture one C—C bond, as determined using extensional flow (De Gennes, P. G., J. Chem. Phys., 60, 5030-5042 (1974); Harrington, R. E., Zimm, B. H., J. Phys. Chem., 69, 161-176 (1965); Odell, J. A., Keller, A., Rabin, Y., J. Chem. Phys., 88, 4022-4028 (1988)), ultrasonic radiation (Basedow, A. M., Ebert, K. H., Adv. Polym. Sci., 22, 83-148 (1977)), receding meniscus (Bensimon, A., Science, 265, 2096-2098 (1994)), and stretching a single molecule using a nanoprobe (Kishino, A., Yanagida, T., Nature, 334, 74-76 (1988); Evans, E., Annual Rev. Biophys. Biomol. Struct., 30, 105-128 (2001); Smith, S. B., Cui, Y., Bustamante, C., Science, 271, 795-799 (1996); Cluzel, P. et al., Science, 271, 792-794 (1996); Mehta, A. D., Rief, M. Spudich, J. A., Smith, D. A., Simmons, R. M., Science, 283, 1689-1695 (1999)). That said, if it were possible to break said covalent C—C bonds without using external stimuli, e.g., temperature, light, sonication, mastication, etc., the energy released upon severance may be harnessed to activate chemical reactions.

It was previously reported that the length of a bond is actually more important than the known energy of said bond (Beyer, M. K., Clausen-Schaumann, H., Chem. Rev., 105, 2921-2948 (2005)). As such, the forces needed to rupture a bond decrease as the length of the bond increases. Accordingly, as a particular bond is extended beyond its equilibrium length, the likelihood that it may rupture spontaneously increases. It is this spontaneous rupture that is the physical process behind the present invention.

Accordingly, there is a need in the art for specially designed branched macromolecules, which upon adsorption at a surface experience intramolecular tension at their covalent bonds due to the physical interaction of molecular segments of the macromolecules with said surface. Furthermore, there is a need in the art for a macromolecule that may be designed to include a pharmaceutical and/or an environmental sensor and that may be manipulated so that tension is induced at a specific bond upon adsorption or spreading of the macromolecule at a surface. The macromolecule of the invention may be used in a number of applications including, but not limited to, environmental sensors, reaction activators, molecular degradation triggers, and molecular probes.

In addition, there is a need in the art for methods of producing monodisperse polymers. Monodisperse polymers are increasingly desirable in industries requiring stringent material characterization and quality control. Polydispersity indices of less than 1.20 are increasingly difficult to prepare using controlled polymerization methods in polymers of molar masses that exceed about 500,000 g mol⁻¹ (generally defined as “high polymers”) (U.S. Pat. No. 7,026,414). Towards that end, another object of the invention is a method for producing monodisperse macromolecules from the specially designed macromolecules described herein.

### SUMMARY OF THE INVENTION

The present invention relates to specially designed macromolecules which upon adsorption at a surface experience intramolecular tension at their covalent bonds due to the physical interaction of the monomeric units of the macromolecules with the surface.

In one aspect, the invention relates to a method of reducing the polydispersity index of a macromolecule composition, said method comprising: providing a macromolecule composition in a fluid medium, said macromolecule composition having an initial polydispersity index; and subjecting the macromolecule composition to a substrate for time sufficient to reduce said polydispersity index to a final polydispersity index, with the provision that the polydispersity index of the macromolecule composition is reduced in the substantial absence of external energy.

In another aspect, the invention relates to a method of sensing environmental properties or delivering a pharmaceutical to a subject in need of said pharmaceutical, said method comprising: providing a macromolecule composition in a fluid medium, said macromolecule composition comprising at least two backbones, a plurality of side chains, and at least one additional species covalently bonded with and positioned between the at least two backbones; and subjecting the macromolecule composition to a substrate for time sufficient to sever at least one covalent bond associated with the at least one additional species to expose the at least one additional species to a surrounding environment, with the provision that the at least one covalent bond associated with the at least one additional species is severed in the substantial absence of external energy.

In still another aspect, the invention relates to a method of activating and accelerating a chemical reaction, said method comprising: providing a macromolecule composition in a fluid medium, said macromolecule composition comprising at least one brushlike macromolecule; subjecting the macromolecule composition to a substrate for time sufficient to sever at least one covalent bond of the brushlike macromolecule; and using the energy released as a result of the covalent bond severance to activate a chemical reaction and/or accelerate a chemical reaction, with the provision that the severance of the covalent bond occurs in the substantial absence of external energy.

Other aspects, features and embodiments of the invention will be more fully apparent from the ensuing disclosure and appended claims.

### BRIEF DESCRIPTION OF THE DRAWINGS

FIG. 1a is a micrograph of the brushlike macromolecules of the invention having a poly(2-hydroxyethyl methacrylate) backbone and poly(n-butyl acrylate) side chains (n=12±1) upon adsorption onto a solid substrate (mica).

FIG. 1b is a micrograph of the brushlike macromolecules of the invention having a poly(2-hydroxyethyl methacrylate) backbone and poly(n-butyl acrylate) side chains (n=130±12) upon adsorption onto a solid substrate (mica).

FIG. 2 is a schematic of the spreading and the bond-tension generation of a brushlike macromolecule on an attractive substrate.

FIG. 3 includes micrographs of the degradation of brushlike macromolecules having a poly(2-hydroxyethyl methacrylate) backbone and poly(n-butyl acrylate) side chains (n=140±12) upon spreading at a water/propanol (99.8/0.2 wt/wt %) substrate at t=5 min (FIG. 3a), t=2 hr (FIG. 3b), t=6 hr (FIG. 3c), t=16 hr (FIG. 3d), and t=42 hr (FIG. 3e).

FIG. 4 illustrates the nearly constant cumulative length of the molecules per unit mass of material measured as a function of time.

FIG. 5 illustrates the average molecular length of the macromolecules of the invention (hollow circles were experimentally determined; solid line was obtained by fitting the experimental points with an equation for the first order reaction) and the polydispersity index (solid squares were experimentally determined; dashed line was computer simulated) as a function of time following adsorption at a substrate.

FIG. 6 illustrates different branched architectures that exhibit different tension distributions and fracture patterns. The thicker, more heavily shaded, lines and dot designate bonds with the highest tension.

FIG. 7 includes AFM micrographs of the macromolecules on various surface-energy substrates including, γ=69.4 mN/m (FIG. 7a), γ=68.7 mN/m (FIG. 7b), γ=68.1 mN/m (FIG. 7c), γ=67.5 mN/m (FIG. 7d), and γ=66.9 mN/m (FIG. 7e). All AFM micrographs were measured after 2 hours of the deposition time. While molecules on a higher surface-energy substrate are almost all ruptured (FIG. 7a), the molecules on a lower surface-energy substrate remain nearly intact (FIG. 7e).

FIG. 8 illustrates the dependence of the scission rate on the surface energy of the substrate: γ=69.4 mN/m (FIG. 7a), γ=68.7 mN/m (FIG. 7b), γ=68.1 mN/m (FIG. 7c), γ=67.5 mN/m (FIG. 7d), and γ=66.9 mN/m (FIG. 7e).

FIG. 9 illustrates how the adsorption-induced tension causes mechanochromism of spriropyran incorporated into the backbone of a brush-like macromolecule. Breaking the weak bond between the nodal carbon atom and the ethereal oxygen results in a change of color from yellow to blue.

### DETAILED DESCRIPTION OF THE INVENTION, AND PREFERRED EMBODIMENTS THEREOF

The present invention is based on the discovery that specially designed branched macromolecules including, but not limited to, brush-like macromolecules, are highly extendable along their backbone upon adsorption onto a substrate. In fact, the macromolecules may be designed to break, at very specific bonds on the backbone, upon adsorption to a substrate. As a result, the macromolecules may be used to activate chemical reactions and to sense environmental and surface properties.

As defined herein, “macromolecules” correspond to molecules with a large molecule mass, including polymers, oligomers, molecules that structurally resemble polymers or oligomers, individual molecules that make up a polymer or oligomer, i.e., according to IUPAC recommendations, and biomacromolecules such as proteins, enzymes, carbohydrates, nucleic acids, and lipids.

As defined herein, a “substrate” corresponds to any solid or liquid that a macromolecule adsorbs to or spreads itself on including, but not limited to, proteinaceous materials such as cells and glucoproteins; solid inorganic materials; solid organic materials; various liquids including water, organic solvents, water/organic solvent mixtures; and any combination thereof. Importantly, the extent of adsorption may cover a range of adhesive forces from high to low adhesion.

As defined herein, the “specific” bond that experiences the adsorption-induced tension may correspond to a known, defined bond and/or an unknown bond. The specific bond is considered as an overstressed bond, i.e. the bond which experiences a higher tension than other bonds in the molecule. The specific bond can be of any nature, i.e. the bond can be chemical (e.g. covalent and metallic) or physical (e.g. hydrogen, ionic, dipole).

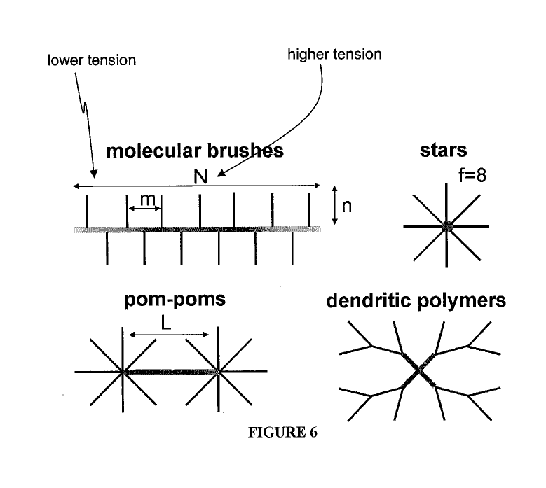

As defined herein, “specially designed macromolecules” correspond to highly branched polymers including, but not limited to, brush-like and star-like macromolecules, dendrimers, and hyperbranched macromolecules, and combinations of thereof, e.g. pom-pom molecules, wherein the spacing between branches is significantly shorter than the length of branches and the overall molecular dimension (see, e.g., FIG. 6).

As defined herein, “brushlike macromolecules” correspond to macromolecules including a backbone having a plurality of straight or branched side chain structures attached to the backbone of the macromolecule. For example, the brushlike macromolecule may resemble a brush with “bristles” or it may have dendritic side groups. The brushlike macromolecules are preferably highly branched, i.e. have a high grafting density (i.e., the spacing between the side chains is much shorter than the length of the side chain length).

As defined herein, “mechanochromism” corresponds to tension induced changes in the photonic properties of a molecule.

As defined herein, an “external energy” corresponds to any energy that is intentionally introduced to the system, e.g., thermal energy, photoenergy, mechanical energy, sonic energy, etc., in order to initiate and/or maintain the scission processes of the invention. It is to be understood that surface energy, mechanical and chemical forces induced by adsorption, and the potential energy associated with the substrate, the macromolecules, and the surrounding environment, e.g., temperature of the facility and everything in it, are not considered external energy for the purposes of this invention.

Hyperbranched macromolecules and dendrimers can generally be described as three dimensional highly branched molecules having a tree-like structure. Dendrimers are highly symmetric, while similar macromolecules designated as hyperbranched may to a certain degree hold an asymmetry, yet maintaining the highly branched tree-like structure. Dendrimers can be said to be monodisperse variations of hyperbranched macromolecules.

As defined herein, “substantial absence of external energy” corresponds to less than 5% of the energy needed to initiate and/or maintain the process of the invention is being provided by an external energy source, preferably less than 2%, more preferably less than 1%, and most preferably, less than 0.5% of the energy of the process is provided by an external energy source.

It was surprisingly discovered by the inventor that when a highly branched, brushlike macromolecule was adsorbed onto a substrate, said macromolecule underwent conformational deformations, often leading to the spontaneous rupture of the macromolecular backbone. Although not wishing to be bound by theory, it is thought that the deformations and scission of the macromolecule is the result of the attractive interaction of the brushlike side chains for the substrate, which in turn induces tension along the macromolecular backbone beyond its physical limit. Knowing this, macromolecules may be specially designed to avoid scission or alternatively, to promote rupture at predetermined covalent bonds along the macromolecular backbone.

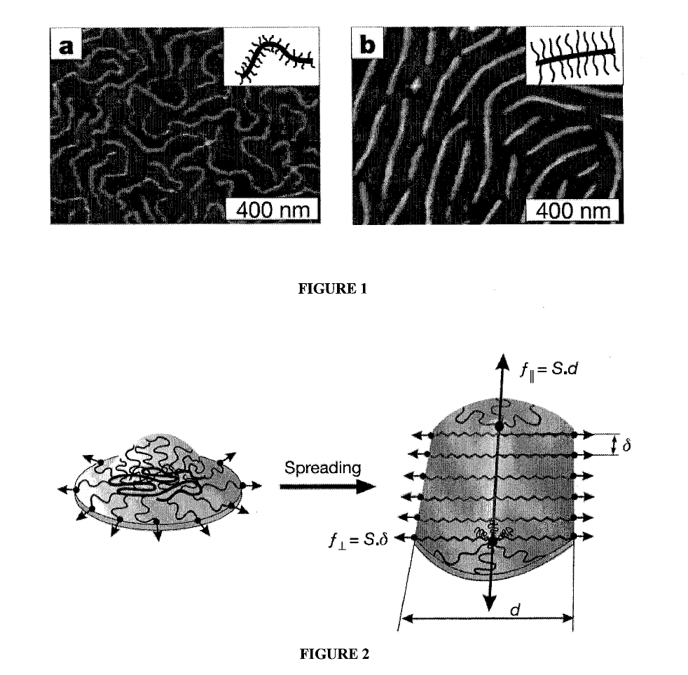

For example, brushlike macromolecules having the same poly(2-hydroxyethyl methacrylate) (Nₙ=2,150±1100) backbone but different poly(n-butyl acrylate) side chains, for example n=12±1 and n=130±12, assume very different conformations upon spreading at a water/propanol (99.8/0.2 wt/wt %) substrate. As shown schematically in FIGS. 1a and 1b, which correspond to atomic force micrographs (Nanoscope 3A, Veeco Metrology Group, Santa Barbara, Calif., USA) of the macromolecule monolayer films following transference to a mica substrate using a Langmuir-Blodgett technique, it can be seen that the backbone of the macromolecules having the short side chains (i.e., n=12±1) adopts a flexible, all-trans conformation (see FIG. 1a). In contrast, the backbone of the macromolecules having the long side chains (i.e., n=130±12), as shown in FIG. 1b, assumes a rod-like all-trans conformation. With regards to the latter, it is thought that the long side chains repel one another thereby stretching the backbone into the rod-like shape. In both cases, the extended conformation of the brushlike macromolecules on the substrate results in a lowering of the surface energy of the system. However, the spreading of the side chains is constrained by the backbone and a “tug of war” ensues. As a result, the backbone must extend into the rod-like conformation to maximize the number of side chain contacts with the substrate, e.g., as shown in FIG. 2.

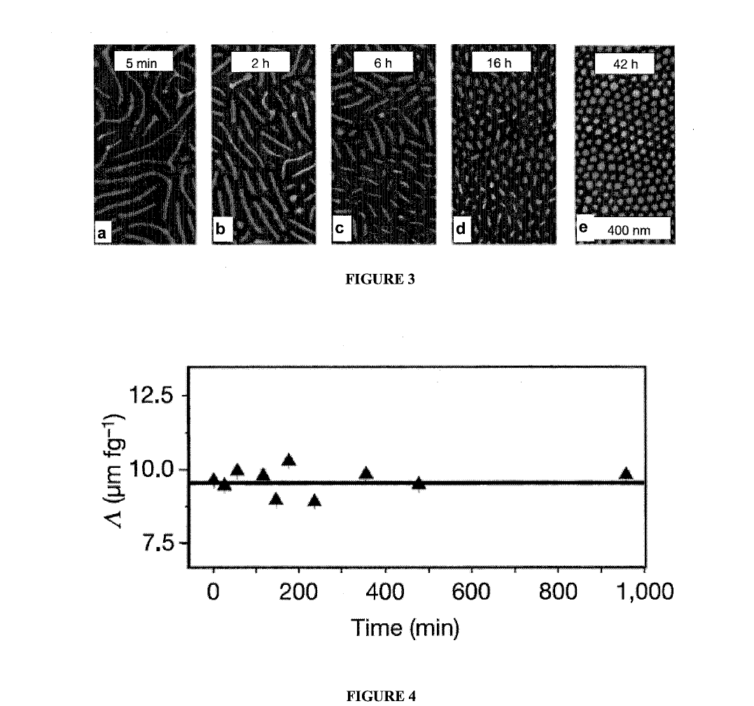

Eventually, the backbone may extend beyond its physical limit and a rupture may occur along the backbone of the macromolecule. As shown in FIGS. 3a-3e, it can be seen that the brushlike macromolecules having a poly(2-hydroxyethyl methacrylate) (Nₙ=2,150 100) backbone with longer (n=140±12) poly(n-butyl acrylate) side chains actually degrade over time upon spreading at the above-mentioned water/propanol substrate (following transfer to a mica substrate as described in the foregoing paragraph). The water/propanol substrate had a surface energy of γ=69±1 mN m⁻¹. It can be seen that with increasing time (5 minutes to 42 hours), the macromolecules get progressively shorter and their number density progressively increases. Eventually, the bond scission ceases and the macromolecules adopt a round (globular) or star-like morphology, which corresponds to the lower tension configuration for the shortened brushlike macromolecules.

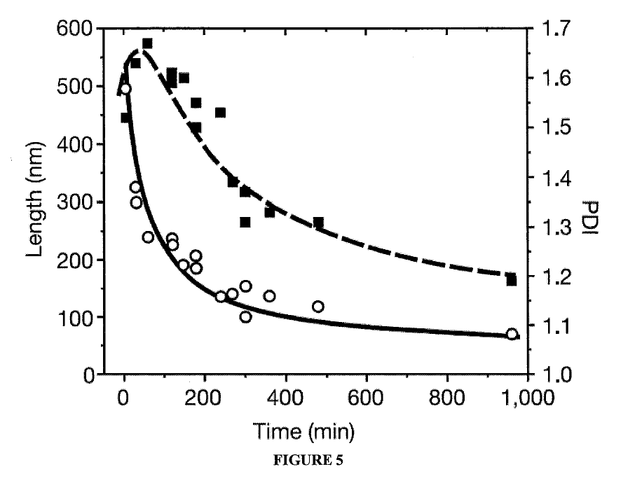

Importantly, the cumulative length of the molecules per unit mass, A, remained approximately constant at 9.6 μm fg⁻¹, as shown schematically in FIG. 4, which is a good indication that scission along the macromolecular backbone occurred over time. Furthermore, random cleavage of the backbone C—C bonds occurs, as supported by the polydispersity index, PDI=L_{w}/Lₙ, where L_{w} and Lₙ are the weight and number average lengths of adsorbed macromolecules, respectively. As shown schematically in FIG. 5, the PDI initially increases and then decreases (black squares represent experimental results while the dashed line was obtained by fitting the experimental points with an equation for the first order reaction), which is consistent with random cleavage of the macromolecules initially followed by the approach to an essentially monodisperse system when the molecules no longer undergo scission. In the present case, the shortest molecules observed were 40 nm in length at a polydispersity index of about 1.2.

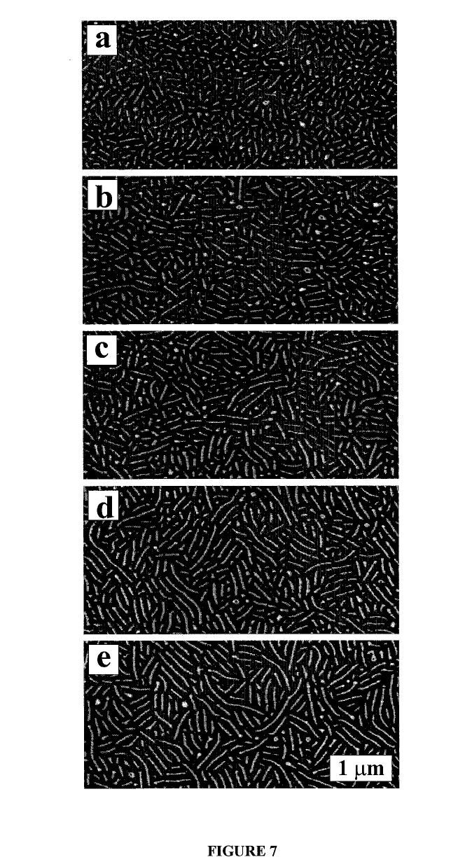

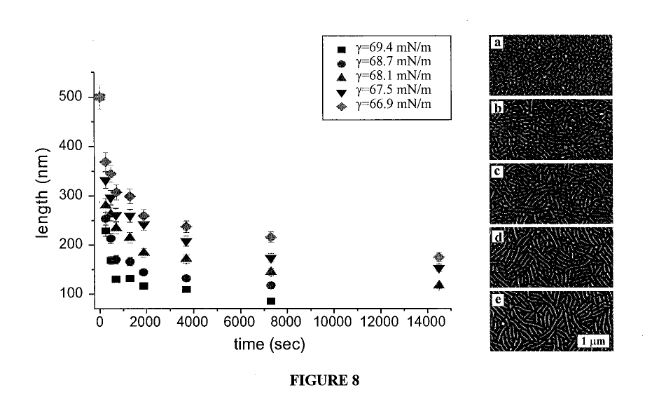

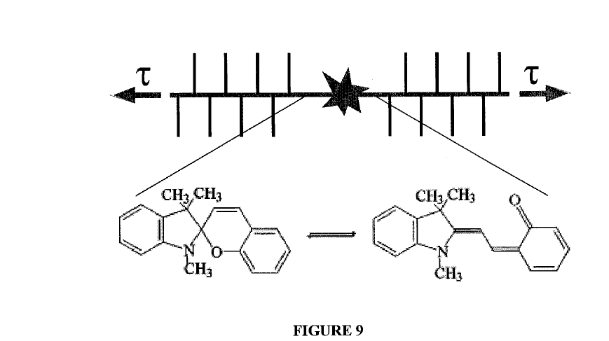

In addition, it was determined that the scission process is also extremely sensitive to variations in the substrate surface energy. As the surface energy of the substrate decreases, the scission rate decreases and brushlike macromolecules cease to undergo scission (see, e.g., FIGS. 7 and 8). For example, as the proportion of propanol in the water/propanol solution increases, such that γ<60 mN m⁻¹, the brushlike macromolecules with the n=140 monomer side chains remained intact. Analogously, it is known that an increase in the surface tension of the surface of just 2 mN/m results in about 2 orders of magnitude increase in the rate constant of the scission reaction. Further, the surface energy of materials usually decreases with increasing temperature (see, e.g., Dee, G. T., et al., Journal of Colloid and Interface Science, 152, 85-103, 1992, and Poser, C. I., Journal of Colloid and Interface Science, 69, 539-548, 1979) and as such, an increase in surface temperature will actually reduce the rate constant, and hence the rate of the scission reaction.

Accordingly, an object of the present invention is to utilize branched macromolecules including, but not limited to, brushlike macromolecules, in the presence of a substrate in a number of applications including, but not limited to, environmental sensors, reaction activators, molecular degradation triggers, and molecular probes.

As introduced hereinabove, the brushlike macromolecules may include a backbone and a plurality of side chains. The backbone may include monomeric units including, but not limited to, alkenes, dienes, amino acids, nucleic acids, arenes, acrylates, alkyl methacrylates, aryl methacrylates, acrylamides, styrenes, vinylpyridines, phenylenes, tolanes, siloxanes, silanes, thiophenes, saccharides, olefins, acetates, esters, terephthlates, carbonates, glycidyls, and combinations thereof. For example, the monomeric species may include methyl methacrylate, ethyl methacrylate, butyl methacrylate, hexyl methacrylate, ethylhexyl methacrylate, isodecyl methacrylate, methacrylic esters, cyclohexyl methacrylate, stearyl methacrylate, benzyl methacrylate, trimethylcyclohexyl methacrylate, alkoxyalkyl methacrylates, hydroxyalkyl methacrylates, 2-hydroxyethyl methacrylate, acrylic acid, alkyl acrylates, butyl acrylate, ethyl acrylate, methyl acrylate, 2-ethylhexyl acrylate, di-methyl acrylamide, isopropylacrylamide, styrene, 2-vinylpyridine, 4-vinylpyridine, vinyl ethylene oxide, p-phenylene ethynylene, p-phenylene vinylene, dimethyl siloxane, thiophene, vinyl acetate, ethylene, butadiene, isoprene, carboxymethylcellulose, hydroxypropyl starch, lignosulfonate, starch, guar gum, xanthan gum, any of the amino acids, and combinations thereof. The monomeric species may be combined to form an oligomeric or polymeric backbone using polymerization techniques well known in the art. The length of the backbone can be any length depending on the desired outcome, as readily determined by one skilled in the art without undue experimentation. Importantly, the monomeric units of the backbone may be the same as or different from one another.

The side chains may include, but are not limited to, monomers such as those enumerated in the foregoing paragraph. Importantly, the side chains may be the same as or different from one another. The side chains may be homopolymers or copolymers (random, block, statistical) including various monomeric units. The monomers may be further substituted with alkanes, alkenes, alkynes, aryls, acetates, amines, amides, aldehydes, ketones, ethers, esters, alcohols, carboxylic acids, etc., and combinations thereof. For example, the side chains may include n-butyl acrylate, di-methylacrylamide, ethylene oxide and combinations thereof. The side chains may be attached to the backbone using techniques well known in the art. For example, the brushlike macromolecules may be synthesized using atom transfer radical polymerization or other controlled radical polymerization techniques (see, e.g., Matyjaszewski, K., Xia, J., Chem. Rev., 101, 2921-2990 (2001)). Preferably, the brushlike macromolecule is synthesized in solution to maximize the degrees of freedom of the macromolecules. Importantly, the monomeric units of the side chains may be the same as or different from one another. The side chains can be any length depending on the desired outcome, as readily determined by one skilled in the art. Stronger attraction to the substrate requires shorter side chains to achieve the same tension on the backbone.

The substrate may comprise any solid or liquid that a macromolecule adsorbs to or spreads on, respectively, including, but not limited to, proteinaceous materials; solid inorganic materials; solid organic materials; various liquids including water, organic solvents, water/organic solvent mixtures; and combinations thereof. Importantly, the extent of adsorption may cover a range of adhesive forces from high to low adhesion, i.e., the adhesion forces are irrelevant so long as the surface is attractive to the brushlike macromolecule. The substrate can be of any topography, e.g. flat, curved, or irregular. Substrate materials contemplated herein include, but are not limited to, cell walls, mammalian fluids such as synovial fluid and blood, mica, graphite, silicon, silicon-containing materials, metals, metal alloys, polymeric materials, semiconductor substrates, water and combinations thereof.

One object of the present invention is to achieve a low polydispersity index (i.e., a high monodispersity) for a macromolecule, wherein the reduction in polydispersity is achieved post-polymerization and through modification, such as a scission or a fracture, of the macromolecule at a substrate.

Towards that end, in one embodiment, the branched macromolecules including, but not limited to, brushlike macromolecules, may be applied to a substrate to produce substantially monodisperse macromolecules having a polydispersity index (PDI) of about 1 to about 1.4. As defined herein, “substantially monodisperse” macromolecules correspond to the macromolecules following the scission process, wherein the PDI of the backbone is about 1 to about 1.4. The length of time necessary to produce substantially monodisperse macromolecules is in a range from about 60 seconds to about 500 minutes depending on the strength of the attraction of the branched macromolecule to the substrate. Preferably, the substantially monodisperse macromolecules are produced from the branched macromolecules without the use of any applied (i.e., external) energy sources or flows. Eventually, one can obtain molecules with even lower polydispersity. The limiting PDI (lower limit) can be controlled by manipulating branching topology, e.g., by inserting more than one side chain per monomeric unit on the backbone, and adsorption strength.

In another embodiment, the branched macromolecules including, but not limited to, brushlike macromolecules, may be engineered such that the plurality of side chains include specific substituents that will chemisorb or physisorb contaminant matter. As a result of the scission process at a substrate, what was formerly one large branched macromolecule may be induced (at a substrate) to become a plurality of substantially monodisperse macromolecules that may be used to remove contaminant matter from a solution or the surface of a solid through sorption processes known in the art. Methods of removal from a solution or the surface of a solid are readily determinable by one skilled in the art without undue influence.

In yet another embodiment, the backbone of the macromolecule may be engineered to include at least one additional species, i.e., as a molecular tweezer, wherein the additional species are selected from the group consisting of a pharmaceutical, a chromophore, a conductive polymer, a dye, or simply a reactive chemical group, and the species are positioned between two lengths of the backbone, wherein the two lengths of the backbone are the same or different in length (see, e.g., FIG. 9, from Todres, Z. V. “Recent advances in the study of mechanochromic transitions of organic compounds,” Journal of Chemical Research, Synopses, Volume 2004, No. 2, 89-93). Importantly, the macromolecule may include n additional species and hence n+1 backbone lengths, where n may be any number from 1 to 100. As a result of induced tension, the introduced species (i.e., chemical groups) will undergo a change in electronic structure and properties. As such, chromophores will change their adsorption and emission spectra, conductive sequences will change their conductivity, and reactive groups will change their reactivity. The magnitude of the foregoing changes will be controlled through molecular design (e.g., branching density and length of the branches) and interactions with the substrate (e.g., surface energy of the substrate). In a particularly preferred embodiment, the specific covalent bond associated with the additional species is engineered to be the weakest one along the length of the macromolecule. Upon adsorption at a substrate, or other changes in the environment of the substrate, the weakened covalent bond undergoes scission and the additional species are exposed to release the pharmaceutical or dye, or expose the chromophore or conductive polymer to sense environmental and/or surface properties.

In yet another embodiment, the branched macromolecules including, but not limited to, brushlike macromolecules, may be used to map the surface properties of thin films. It was shown that both the bond tension and the scission rate of brushlike macromolecules depend on the surface energy of the substrate. Variations in tension can be sensed through changes in the adsorption/emission spectra of chromophores inserted into the macromolecule. For example, FIG. 9 illustrates how the adsorption-induced tension causes mechanochromism of the spriropyran molecule that was incorporated into the backbone of a brush-like macromolecule. Breaking the weak bond between the nodal carbon atom and the ethereal oxygen results in a change of color from yellow to blue.

In still another embodiment, the branched macromolecules including, but not limited to, brushlike macromolecules, may be engineered for tribological use, pharmaceutical use, medicinal use, surface coatings, heterogeneous catalysis, lithography, and further designed to undergo degradation, including bio-, photo-, thermal, mechanical and chemical degradation, when their usefulness is compromised.

In another embodiment, the energy released upon the scission of a covalent bond along the backbone of the branched macromolecules including, but not limited to, brushlike macromolecules, may be utilized to activate chemical reactions and/or accelerate chemical reactions at specific sites within the macromolecules and/or at specific areas of the substrate which the macromolecules adsorbs to.

The features and advantages of the invention are more fully illustrated by the following non-limiting examples, wherein all parts and percentages are by weight, unless otherwise expressly stated.

### EXAMPLE 1

Branched macromolecules, upon spreading at a water/propanol (99.8/0.2 wt/wt %) substrate, which has a surface energy of about γ=68.3 mN/m, had a reaction constant of about 2×10⁻⁵ sec⁻¹. At this rate, it takes ˜10 hours to obtain substantially monodisperse macromolecules (PDI=1.2).

Reducing the fraction of propanol to 0.05 wt %, results in an increase of surface tension up to γ=69.4 mN/m, which results in a much higher reaction constant (about 5×10⁻⁴ sec⁻¹). This means that the polydispersity index (PDI=1.2) will be obtained within ˜1 hour.

On pure water with a surface energy of about γ=72.3 mN/m, one expects a reaction constant of about 10⁻² sec⁻¹ (cannot be measured as it is too fast). At such a high reaction constant, the reaction should take less then a second to obtain macromolecules with a polydispersity index of PDI=1.2.

Accordingly, while the invention has been described herein in reference to specific aspects, features and illustrative embodiments of the invention, it will be appreciated that the utility of the invention is not thus limited, but rather extends to and encompasses numerous other aspects, features and embodiments that result from the adsorption-induced tension in molecular (chemical and physical) bonds of adsorbed macromolecules and macromolecular assemblies. Accordingly, the claims hereafter set forth are intended to be correspondingly broadly construed, as including all such aspects, features and embodiments, within their spirit and scope.

What is claimed is:

1. A method of reducing the polydispersity index of a macromolecule composition, said method comprising: providing a macromolecule composition in a fluid medium, said macromolecule composition having an initial polydispersity index; and subjecting the macromolecule composition to a substrate for time sufficient to reduce said polydispersity index to a final polydispersity index, with the provision that the polydispersity index of the macromolecule composition is reduced in the substantial absence of external energy.

2. The method of claim 1, wherein the macromolecule composition comprises a branched macromolecule selected from the group consisting of brushlike macromolecules, starlike macromolecules, dendrimers, hyperbranched macromolecules, and combinations thereof.

3. The method of claim 2, wherein the brushlike macromolecules comprises a backbone and a plurality of side chains.

4. The method of claim 3, wherein the backbone comprises at least one monomeric unit selected from the group consisting of methyl methacrylate, ethyl methacrylate, butyl methacrylate, hexyl methacrylate, ethylhexyl methacrylate, isodecyl methacrylate, methacrylic esters, cyclohexyl methacrylate, stearyl methacrylate, benzyl methacrylate, trimethylcyclohexyl methacrylate, alkoxyalkyl methacrylates, hydroxyalkyl methacrylates, 2-hydroxyethyl methacrylate, acrylic acid, alkyl acrylates, butyl acrylate, ethyl acrylate, methyl acrylate, 2-ethylhexyl acrylate, di-methyl acrylamide, isopropylacrylamide, styrene, 2-vinylpyridine, 4-vinylpyridine, vinyl ethylene oxide, p-phenylene ethynylene, p-phenylene vinylene, dimethyl siloxane, thiophene, vinyl acetate, ethylene, butadiene, isoprene, carboxymethylcellulose, hydroxypropyl starch, lignosulfonate, starch, guar gum, xanthan gum, amino acids, and combinations thereof.

5. The method of claim 3, wherein the plurality of side chains comprise at least one monomeric unit selected from the group consisting of alkenes, dienes, amino acids, nucleic acids, arenes, acrylates, alkyl methacrylates, aryl methacrylates, acrylamides, styrenes, vinylpyridines, phenylenes, tolanes, siloxanes, silanes, thiophenes, saccharides, olefins, acetates, esters, terephthlates, carbonates, glycidyls, and combinations thereof.

6. The method of claim 1, wherein the substrate comprises a material selected from the group consisting of proteinaceous materials, solid inorganic materials, solid organic materials, water, organic solvents, water/organic solvent mixtures, and combinations thereof.

7. The method of claim 1, wherein the final polydispersity index is less than the initial polydispersity index.

8. The method of claim 1, wherein the final polydispersity index is in a range from about 1 to about 1.4.

9. A method of sensing environmental properties or delivering a pharmaceutical to a subject in need of said pharmaceutical, said method comprising: providing a macromolecule composition in a fluid medium, said macromolecule composition comprising at least two backbones, a plurality of side chains, and at least one additional species covalently bonded with and positioned between the at least two backbones; and subjecting the macromolecule composition to a substrate for time sufficient to sever at least one covalent bond associated with the at least one additional species to expose the at least one additional species to a surrounding environment, with the provision that the at least one covalent bond associated with the at least one additional species is severed in the substantial absence of external energy.

10. The method of claim 9, wherein the macromolecule composition comprises a branched macromolecule selected from the group consisting of brushlike macromolecules, dendrimers, starlike macromolecules, hyperbranched macromolecules, and combinations thereof.

11. The method of claim 9, wherein the backbone comprises at least one monomeric unit selected from the group consisting of methyl methacrylate, ethyl methacrylate, butyl methacrylate, hexyl methacrylate, ethylhexyl methacrylate, isodecyl methacrylate, methacrylic esters, cyclohexyl methacrylate, stearyl methacrylate, benzyl methacrylate, trimethylcyclohexyl methacrylate, alkoxyalkyl methacrylates, hydroxyalkyl methacrylates, 2-hydroxyethyl methacrylate, acrylic acid, alkyl acrylates, butyl acrylate, ethyl acrylate, methyl acrylate, 2-ethylhexyl acrylate, di-methyl acrylamide, isopropylacrylamide, styrene, 2-vinylpyridine, 4-vinylpyridine, vinyl ethylene oxide, p-phenylene ethynylene, p-phenylene vinylene, dimethyl siloxane, thiophene, vinyl acetate, ethylene, butadiene, isoprene, carboxymethylcellulose, hydroxypropyl starch, lignosulfonate, starch, guar gum, xanthan gum, amino acids, and combinations thereof.

12. The method of claim 9, wherein the plurality of side chains comprise at least one monomeric unit selected from the group consisting of alkenes, dienes, amino acids, nucleic acids, arenes, acrylates, alkyl methacrylates, aryl methacrylates, acrylamides, styrenes, vinylpyridines, phenylenes, tolanes, siloxanes, silanes, thiophenes, saccharides, olefins, acetates, esters, terephthlates, carbonates, glycidyls, and combinations thereof.

13. The method of claim 9, wherein the at least one additional species comprises a chromophore, a dye, a conductive polymer, a pharmaceutical, and combinations thereof.

14. The method of claim 9, wherein the at least two backbones comprise the same number or a different number of monomeric units.

15. The method of claim 13, wherein the at least one additional species comprises a pharmaceutical and wherein the substrate comprises a material selected from the group consisting of a cell wall, mammalian fluid, and combinations thereof.

16. A method of activating and accelerating a chemical reaction, said method comprising: providing a macromolecule composition in a fluid medium, said macromolecule composition comprising at least one brushlike macromolecule; subjecting the macromolecule composition to a substrate for time sufficient to sever at least one covalent bond of the brushlike macromolecule; and using the energy released as a result of the covalent bond severance to activate a chemical reaction and/or accelerate a chemical reaction, with the provision that the severance of the covalent bond occurs in the substantial absence of external energy.

17. The method of claim 16, wherein the brushlike macromolecules comprises a backbone and a plurality of side chains.
